(19) United States
(12) Patent Application Publication
(10) Pub. No.: US 2022/0366341 A1
(43) Pub. Date: Nov. 17, 2022

(54) SYSTEM AND METHOD FOR MANAGING DATASET QUALITY IN A COMPUTING ENVIRONMENT

(71) Applicant: Dataworkz Inc, Campbell, CA (US)

(72) Inventors: Sachin Smotra, Pleasanton, CA (US); Nikhil Smotra, Walnut Creek, CA (US); Gourav Sharma, New Delhi (IN); Tejaswini Oduru, Brambleton, VA (US)

(73) Assignee: Dataworkz Inc

(21) Appl. No.: 17/321,556

(22) Filed: May 17, 2021

(51) Int. Cl. G06Q 10/06; G06F 16/215; G06F 16/23; G06F 16/26; G06F 11/34; G06F 11/30

(52) U.S. Cl. CPC G06Q 10/06375; G06F 16/215; G06F 16/2365; G06F 16/26; G06F 11/3409; G06F 11/3086

(57) ABSTRACT

A system for managing dataset quality in a computing environment is disclosed. The plurality of subsystems includes a data receiving subsystem, configured to receive a dataset. The plurality of subsystems includes a data analysis subsystem configured to compute data metrics for each field of the received dataset based on type of the dataset. The data analysis subsystem assigns a domain label for each of the received dataset based on the computed data metrics. Further, the data analysis subsystem compares the computed data metrics and the assigned domain label for each field of the received dataset with stored values of data metrics and domain label for pre-processed non-anomalous datasets to determine a one or more deviations. The data analysis subsystem is configured to determine a statistical difference between the values of received dataset and non-anomalous historical dataset.

### FIELD OF INVENTION

Embodiments of the present disclosure relate to data analytics, and more particularly to a system and a method for managing dataset quality in a computing environment.

### BACKGROUND

Humans tend to generate a lot of data. The generation of the data is not limited to technological companies alone. Businesses as diverse as life-insurers, hotels, and the like are now using the data to improve marketing strategies and improve customer experience. The data generated enables the companies to understand business trends or otherwise collect valuable insights on users. As the volume of the data increases daily, it is very challenging for companies to keep track of any anomalous data.

In a conventional approach, a company's team invests workforce and time in detecting an anomaly in the data. Additionally, “timeliness” of the data is very short, requiring higher processing technology to constantly monitor the changes in the data and detect anomaly in such changed data.

Due to the high dependency on manual effort for detecting an anomaly in the data, human errors could be made while detecting the anomaly. Furthermore, accuracy in detecting such anomaly in the data may not be so high, which results in the poor quality of the data.

Further, assessing the data quality of the data is exacerbated when multiple systems are writing the data to a data lake. Raw data that is written to the data lake is processed and transformed in multiple ways for downstream usage, thus making the use of standard data quality conventions such as row counts, ad-hoc scripts, and simple range approaches ineffective. Further, as machine learning technologies penetrate the companies, the output of one predictive model will feed the next, and the next, and so on. The risk in this process is that a minor error at one step will cascade, causing more errors. The errors shall grow larger across an entire process, leading to poor quality of the data.

Hence, there is a need for an improved system and method for managing dataset quality in a computing environment and therefore address the aforementioned issues.

### SUMMARY

In accordance with one embodiment of the present disclosure, a system for managing dataset quality in a computing environment is disclosed. The system includes a hardware processor. The system also includes a memory coupled to the hardware processor. The memory comprises a set of program instructions in the form of a plurality of subsystems and configured to be executed by the hardware processor.

The plurality of subsystems includes a data receiving subsystem. The data receiving subsystem is configured to receive a dataset from one or more data sources. In such embodiment, the received dataset comprises at least one or more fields which may include numerical type, date type, date time type or textual type and an optional header.

The plurality of subsystems also includes a data analysis subsystem. The data analysis subsystem is configured to compute data metrics for each field of the received dataset based on dataset type. The data analysis subsystem is also configured to assign domain label for each field of the received dataset using either natural language processing models or regular expression matches.

The data analysis subsystem is also configured to compare the computed data metrics and the assigned domain label for each field of the received dataset with stored values of data metrics and domain label for historical non-anomalous datasets to determine one or more deviations.

The data analysis subsystem is also configured to determine statistical differences between the received dataset and stored historical datasets that have been already processed by the subsystem. The plurality of subsystems also includes a quality output subsystem. The quality output subsystem is configured to output the determined statistical difference on a user interface.

In accordance with one embodiment of the disclosure, a method for managing dataset quality in a computing environment is disclosed. The method includes receiving a dataset from one or more data sources. The method also includes computing data metrics (examples include null values, blank values, total unique value count, and total record count, minimum value, maximum value, difference between maximum and minimum values, average value, the ratio of null values count to total record count and the ratio of unique values count to total record count) for each field of the received dataset based on its type. The method also includes assigning domain label for each field of the received dataset using either natural language processing models or regular expression matches.

The method also includes comparing the calculated data metrics and domain label for each field of the received dataset with data metrics and domain labels for non-anomalous datasets that have been processed by the system in the past to determine deviation. The method also includes determining the statistical difference between data metrics value for the received dataset and non-anomalous datasets that have already been processed in the past. The method also includes outputting the determined statistical difference on a user interface.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1A is a block diagram illustrating an exemplary computing system for managing dataset quality in a computing environment in accordance with an embodiment of the present disclosure;

FIG. 1B is a system architecture illustrating detailed view of the exemplary computing system, as shown in FIG. 1A, in accordance with an embodiment of the present disclosure.

FIG. 2 is a block diagram illustrating another exemplary computing system for managing dataset quality in a computing environment in accordance with an embodiment of the present disclosure;

FIG. 3 is a graphical user interface screenshot depicting alert screens in accordance with an embodiment of the present disclosure;

FIG. 4 is a graphical user interface screenshot depicting insight information report in accordance with an embodiment of the present disclosure;

FIG. 5A is a graphical user interface screenshot for data quality catalogue for identified anomaly in accordance with an embodiment of the present disclosure;

FIG. 5B is a graphical user interface screenshot for detailed view of the data quality catalogue, as shown in FIG. 5A, in accordance with an embodiment of the present disclosure;

FIG. 6 is a schematic representation showcasing flow of identified anomaly data in downstream data use in accordance with an embodiment of the present disclosure;

FIG. 7 is a graphical user interface screenshot depicting a dashboard in accordance with an embodiment of the present disclosure;

FIG. 8 is a graphical user interface screenshot depicting an impact analysis screen for any dataset analysis in accordance with an embodiment of the present disclosure;

FIG. 9 is a block diagram illustrating various components in the computing system, such as those shown in FIG. 1, in accordance with an embodiment of the present disclosure; and

FIG. 10 is a process flowchart illustrating an exemplary method for managing dataset quality in a computing environment in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures, and specific language will be used to describe them. It will nevertheless be understood that no limitation of the scope of the disclosure is thereby intended. Such alterations and further modifications in the illustrated online platform and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, subsystems, elements, structures, components, additional devices, additional subsystems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

A computer system (standalone, client or server computer system) configured by an application may constitute a “subsystem” that is configured and operated to perform certain operations. In one embodiment, the “subsystem” may be implemented mechanically or electronically, so a subsystem may comprise dedicated circuitry or logic that is permanently configured (within a special-purpose processor) to perform certain operations. In another embodiment, a “subsystem” may also comprise programmable logic or circuitry (as encompassed within a general-purpose processor or other programmable processor) that is temporarily configured by software to perform certain operations.

Accordingly, the term “subsystem” should be understood to encompass a tangible entity, be that an entity that is physically constructed permanently configured (hardwired) or temporarily configured (programmed) to operate in a certain manner and/or to perform certain operations described herein.

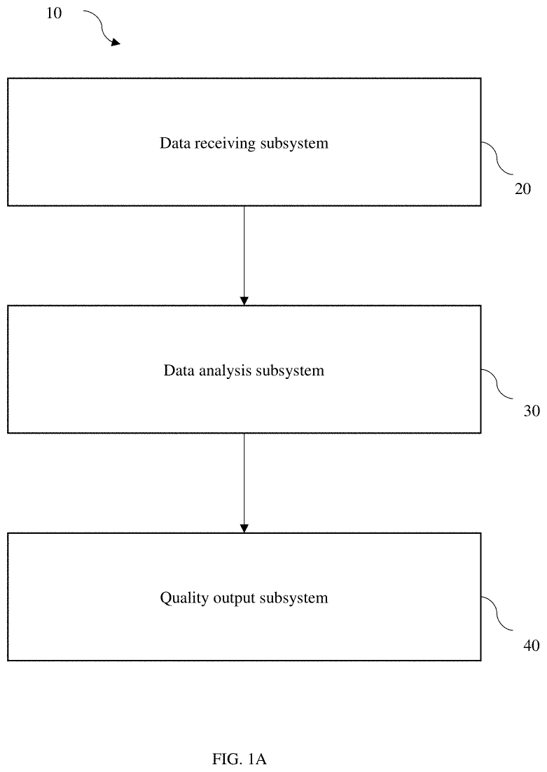

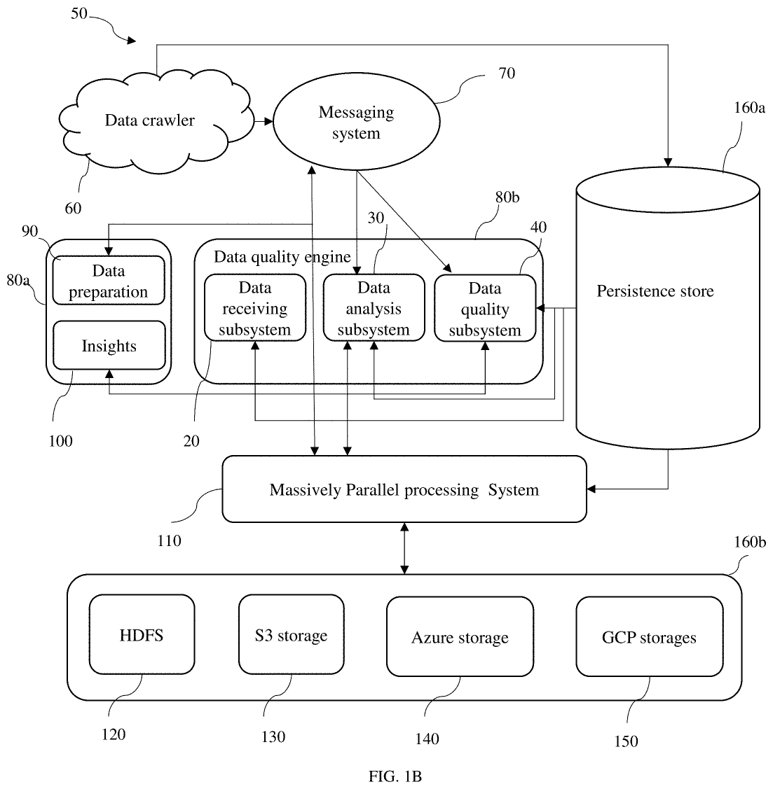

FIG. 1A is a block diagram illustrating an exemplary computing system 10 for managing dataset quality in a computing environment in accordance with an embodiment of the present disclosure. The system 10 described herein automatically detects any incoming data if it is anomalous. Such system 10 for managing dataset quality minimizes the impact of anomalous data on any downstream applications and further quantifies the impact of the anomalous data in an organization.

The system 10 includes a hardware processor 220. The system 10 also includes a memory 200 coupled to the hardware processor 220. The memory 200 comprises a set of program instructions in the form of a plurality of subsystems and configured to be executed by the hardware processor 220.

The plurality of subsystems includes a data receiving subsystem 20. The data receiving subsystem 20 is configured to receive a dataset from one or more data sources. The received dataset comprises one or more columns or fields. The received dataset comprises numerical type, date type, date time type or text type. The received dataset comprises one or more fields and an optional header—where fields represent the actual data residing in the columns and headers represents the column names. The system 10 uses a data crawler to automatically detect and catalogue any newly added datasets. Such process helps is tagging and storing the detected upcoming dataset in the database. In one specific embodiment, one or more data sources may input the dataset for any number of organizations.

The plurality of subsystems further includes a data analysis subsystem 30 configured to compute data metrics for each field of the received dataset based on its type using Apache Spark, a massively parallel processing engine. As used herein, the term “massively parallel processing” refers to using a large number of computer processors to perform a set of coordinated computations in parallel simultaneously. In such embodiment, the computed data metrics for each field include—null values, blank values, total unique value count, total record count, minimum value, maximum value, average value, difference between minimum and maximum values, the ratio of null values count to total record count and the ratio of unique values count to total record count.

In another embodiment, the computed data metrics for each numeric field include—blank values, total unique value count, total record count, minimum value, maximum value, average value, difference between maximum and minimum values and ratio of blank values to total record count. In yet another embodiment, the computed data metrics for the text field include—null count, blank count, total record count, unique record count, the maximum number of characters, the minimum number of characters, average number of characters, count of special characters, the ratio of special characters to alphanumeric characters, the ratio of null values count to total record count and the ratio of unique values count to total record count. In yet another embodiment, the computed data metrics for the date time field include—null count, total record count, unique record count, maximum date value, minimum date value, difference between maximum and minimum value, the ratio of null values count to total record count and the ratio of unique values count to total record count.

Simultaneously, the data analysis subsystem 30 is also configured to assign domain label for each field of the received dataset using either natural language processing models or regular expression matches. As used herein, the term “natural language processing model” is a subfield of linguistics, computer science, and artificial intelligence concerned with the interactions between computers and human language. In particular, the natural language processing model defines how to program computers to process and analyse large amounts of natural language data. In one embodiment, the domain label comprises details such as social security number, credit card number, phone number, email address, individual name, address details, gender, identifying dates, URLs, zip codes, locations, political and religious organizations, and company names.

In assigning the domain label, the data analysis subsystem 30 is configured to determine data set patterns associated with each field of the received dataset based on regular expression matching technique and natural language processing models. Regular expressions are used in extracting information from any text by searching for one or more matches of a specific search pattern—fields of application range from validation to parsing/replacing strings. The system 10 uses regular expressions to determine email, SSN, phone number, credit card number, URL, gender patterns in the text data. Below are the example patterns for each of them.

“\hat{ }[a-zA-Z0-9+_.-]+@[a-zA-Z0-9.-]+”—email

“(0/91)?[7-9] [0-9] {9}”—Phone number

“\hat{ }(?!666100019\\d{2})\\d{3}-(?!00)\\d{2}-(?!0{4})\\d{4}”—SSN

“((httplhttps)://)(www.)?”+“[a-zA-Z0-9 @:%._\\+-#?&//=] {2,256} \.[a-z]”+“{2,6}\\b([-a-zA-Z0-9@: %._\\+˜#?&//=]*)” URL

“\hat{ }3 [47] [0-9] {13}”—Credit Card

The data analysis subsystem 30 is further configured to classify each field that did not match the regular expression matching criteria using the natural language processing model and models to identify street address and zip code. These models parse the text type data to identify patterns of street address and zip code. Furthermore, the data analysis subsystem 30 is configured to compare the calculated data metrics and the domain label for each field of received dataset with data metrics and labels values for non-anomalous datasets that have been processed by the system in the past to determine one or more deviations. The one or more deviations may be a data deviation and/or a data type deviation, indicating the presence of an anomaly in the received dataset.

Let us assume a dataset that contains three fields and columns named col_1, col_2, col_3. Datatypes for the columns are as follows:

col_1->String

col_2->Long

col_3->Date

In another example, let us assume that this dataset contains an optional header and ten rows of as shown below:

col_1, col_2, col_3

Justin fields, 20, 2001/02/01

Chris olave, 21, 2000/10/11

Garrett wilson, 18, 2003/12/24

ryan day, 42, 1980/04/06

urban meter, 57, 1965/02/20

Null, 20, 2001/09/17

Trey sermon, 22, 1999/08/23

Shaun Wade, 21, null

Haskell Garrett, 24, null

Master tease, 19, 2002/09/11

For the above given dataset, the data metrics is computed as follows:

For col_1, total_count=10

blank_count=0

null_count=1

unique_value_count=9

Maximum_length=15

minimum_length=8

average_length=11.77

Difference between maximum and minimum=7

Ratio of null values to total record count=1/10

Ratio of unique values to total record count=9/10

For col_2, total_count=10

blank_count=0

null_count=0

unique_value_count=8

Maximum_value=57

minimum_value=18

average_value=26.4

Difference between maximum and minimum=39

Ratio of null values to total record count=0/10

Ratio of unique values to total record count=8/10

For col_3, total_count=10

blank_count=0

null_count=2

unique_value_count=8

Maximum_value=2003/12/24

minimum_value=1965/02/20

Difference between maximum and minimum (in terms of number of days)=14186

Ratio of null values to total record count=2/10

Ratio of unique values to total record count=8/10

Domain tag/label

col_1->Name

col_2->Number

col_3->Date

The data analysis subsystem 30 is further configured to determine if calculated metrics and domain label for the received dataset are statistically different from historically observed values for data metrics and domain labels. The statistical difference between each field of the incoming dataset and the pre-stored data is determined by applying empirical rule. The empirical rule refers to a statistical distribution of data within three standard deviations from the mean on a normal distribution. The system 10 uses Z-score to calculate how many standard deviations away from the mean is a particular score. Data beyond three standard deviations away from the mean will have z-scores beyond −3 or +3. Hence, if for a specific field, the z-score is found to be more than 3, it means that the field does not follow the empirical rule. Any metric for an incoming dataset having a z-score greater than 3 is flagged as an anomalous deviation.

After such comparison, the data analysis subsystem 30 is configured to determine if there is a significant statistical difference (absolute value of z-score>3) between the data metrics for each field of received dataset and non-anomalous datasets that have been processed in the past. The statistical difference indicates data quality of the received dataset.

In one embodiment, the data deviation refers to z-score greater than 3 for any metric for a given field in an incoming dataset. In such embodiment, the data deviation refers to z-score>3 for any one of the calculated data metrics−average length, count of special characters, ratio of special characters to alphanumeric characters, minimum length, maximum length, ratio of null values to total record count, ration of unique value counts to total record etc. Similarly, to determine the data type deviation, the data analysis subsystem 30 uses named entity recognition (NER) in the form of natural language processing (NLP) and regular expression matching to detect whether the data represents a location, organization, person name, date, product, money, percent, event, email, phone number, credit card or URL.

Upon determining statistical deviation for one or more fields or a change in the domain label for received dataset, the data analysis subsystem 30 is further configured to generate a notification message. In one embodiment, a notification message is generated for any metric for any field in the incoming dataset that has a z-score>3. The notification message contains details for deviations for each metric for each field as well as information regarding change in data semantics for incoming data when compared against domain labels assigned to fields for non-anomalous historical datasets. In one specific embodiment, the data analysis subsystem 30 is configured to generate a notification message based on at least one of the calculated statistical difference between data metrics values or change in data semantics corresponding to the assigned domain label.

FIG. 1B is a system architecture illustrating detailed view of the exemplary computing system, as shown in FIG. 1A, in accordance with an embodiment of the present disclosure. At step 60, the system 10 via a data crawler detects upcoming dataset ingested by the data lake. At step 90, a user may perform a data preparation operation. The process creates an entry in the messaging system 70 for instance of data that is being currently processed. At step 80, the data quality is assured by a data quality engine. The data quality engine comprises the data receiving subsystem 20, the data analysis subsystem 30 and the data quality subsystem.

At step 110, data analysis subsystem 30 uses the massively parallel processing system to calculate metrics for each field in the data. Furthermore, the data analysis subsystem 30 uses the massively parallel processing system to determine domain tag for each field in the data. Such determined data are being stored at persistent store 160. The comparison of stored metrics for the data with historical data is being done to check for anomalies/deviations. In such embodiment, the massively parallel processing system uses various storage facilities such as Hadoop Distributed File System (HDFS) 120, S3 storage 130, Azure storage 140 and GCP storage 150.

Additionally, the plurality of subsystems includes a quality output subsystem 40. The quality output subsystem 40 is configured to output the determined statistical difference on a user interface. Hence, the system 10 enables determination of one or more data quality issues associated with the received dataset based on the determined statistical difference. In one such embodiment, the system 10 enables generation of one or more solutions for rectifying the determined one or more data quality issues based on one or more data quality rules.

The plurality of subsystems further includes a storage subsystem. The storage subsystem is configured to store the computed data metrics and the assigned domain label for each field in the received dataset for use in subsequent runs.

The plurality of subsystems further includes a data dashboard subsystem. The data dashboard subsystem generates an alert message, in response to the anomaly. In one embodiment, the generated recommendation message comprises one or more actions to be performed on the dataset. In one embodiment, one or more actions include replacing dirty, erroneous and missing data with either static constants or dynamic values by executing pre-defined functions. The system 10 further enables capturing one or more actions performed by the user in response to the deviation(s) identified by the subsystem and learn from the one or more actions (of the past) to make better recommendations (in the future). In such embodiment, the system further updates the database with the learnt one or more actions performed on the dataset.

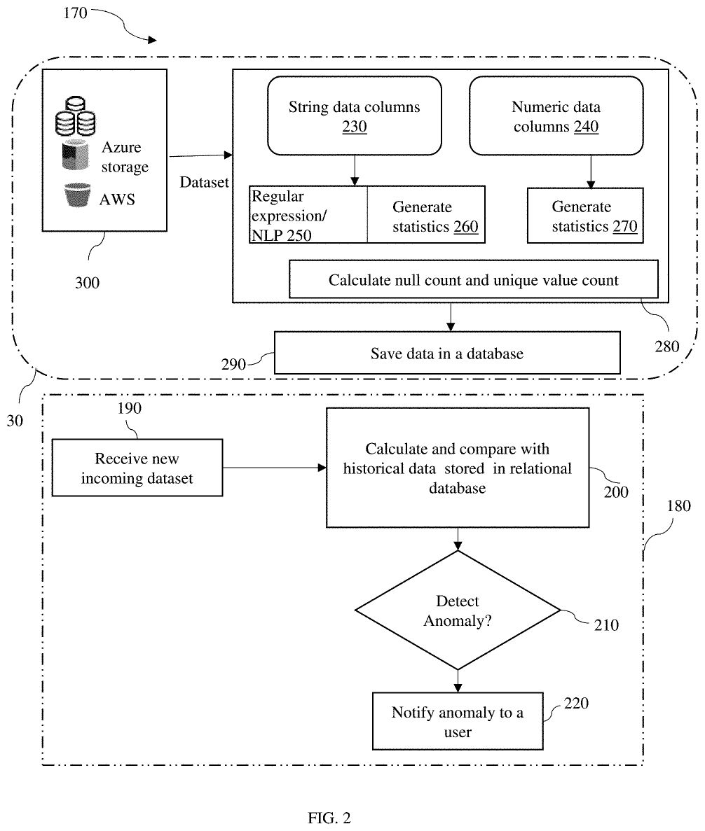

FIG. 2 is a block diagram illustrating another exemplary computing system 170 for managing dataset quality in a computing environment in accordance with an embodiment of the present disclosure. At step 190, the system 170 is configured to receive a new dataset from one or more data sources. For example, a data lake 180 in the data receiving subsystem 20 receives a new dataset from a business organization. The new dataset will contain at least one or more columns or fields which may be of the following types—numerical type, date type, datetime type or textual type.

At step 200, system 170 is further configured to compute data metrics for each field and determine deviation in the received dataset using the computed data metrics. In order to compute data metrics, the data analysis subsystem 30 first calculates null values, blank values, total unique value count, and total record count for all the fields of non-anomalous historical datasets. The system 170 calculates data metrics 260 for text type fields in the dataset 230. The system 170 also calculates data metrics 270 for numeric type fields in the dataset 240. For numeric fields in the dataset 240, data metrics 270 such as minimum, maximum, mean, standard deviation, average are calculated. In another such embodiment, for text type fields in the dataset 230, data metrics 260 such as maximum length, minimum length, average length of the words, count of special characters, ratio of special characters to alphanumeric characters, the ratio of null values count to total record count and the ratio of unique values count to total record count are calculated.

A massively parallel processing engine and a natural language processing engine 250 are used to label each field of the data in-accordance with one or more domain categories such as social security number, credit card number, phone number, email address, individual name, address details and organization name.

At step 200, system 170 compares the computed data metrics for each field of the incoming dataset with the pre-stored historical data metrics. The comparison provides details of anomalies present within the received dataset 70.

At step 210, system 170 is configured to identify anomaly 210 in the received dataset. System 170 here detects the data deviation and the data type deviation, thereby identifying an anomaly. At step 210, system 1700 is configured to generate an alert or notification to the user. With the help of the quality output subsystem 40, the anomaly will be notified 210 to the user via any user interface.

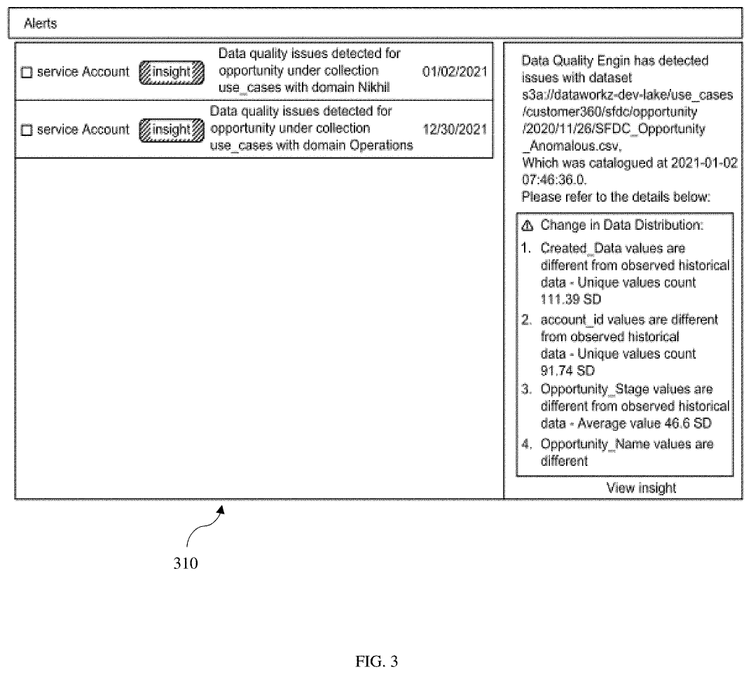

FIG. 3 is a graphical user interface screenshot 310 depicting an alert screen in accordance with an embodiment of the present disclosure. The alert notification clearly states what issues the system 10 has detected with particular dataset. The user may easily access the insight information report via this graphical user interface window. In an embodiment, the system 10 identifies deviations at column or headers level for any instance of data flowing into a dataset. These deviations are surfaced to stakeholders via an alerts screen. An end user can view all alerts that have been generated by the system 10 using a web application.

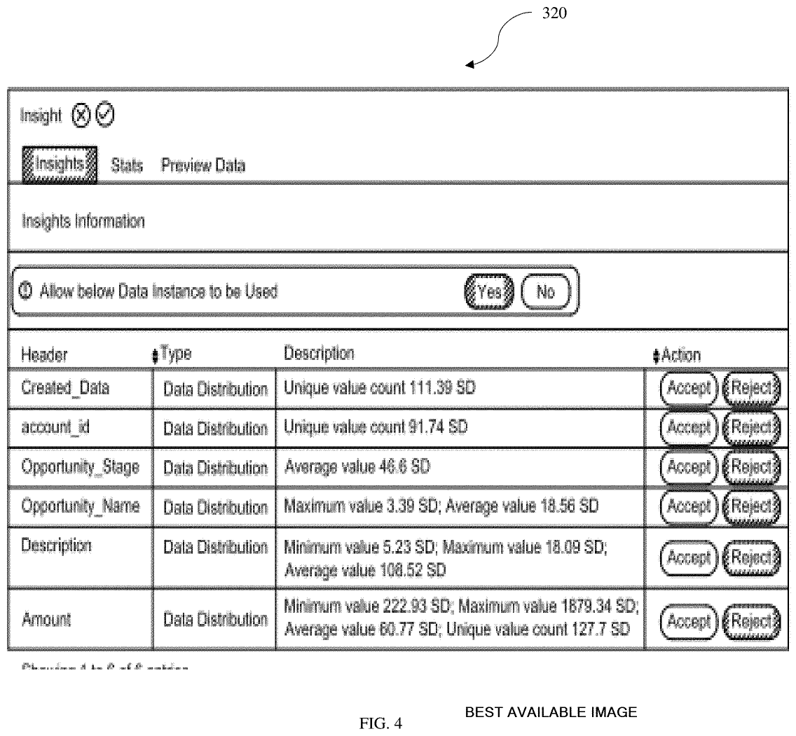

FIG. 4 is a graphical user interface screenshot 320 depicting insight information report in accordance with an embodiment of the present disclosure. The user may agree or disagree with some or all of the column level deviations that have been identified by the system. A user may click on the ‘Accept’ button to agree with the system recommendation or click on the ‘Reject’ button to disagree. The system 10 treats normal columns as “non-anomalous status” and columns with deviation as “pending decision status”.

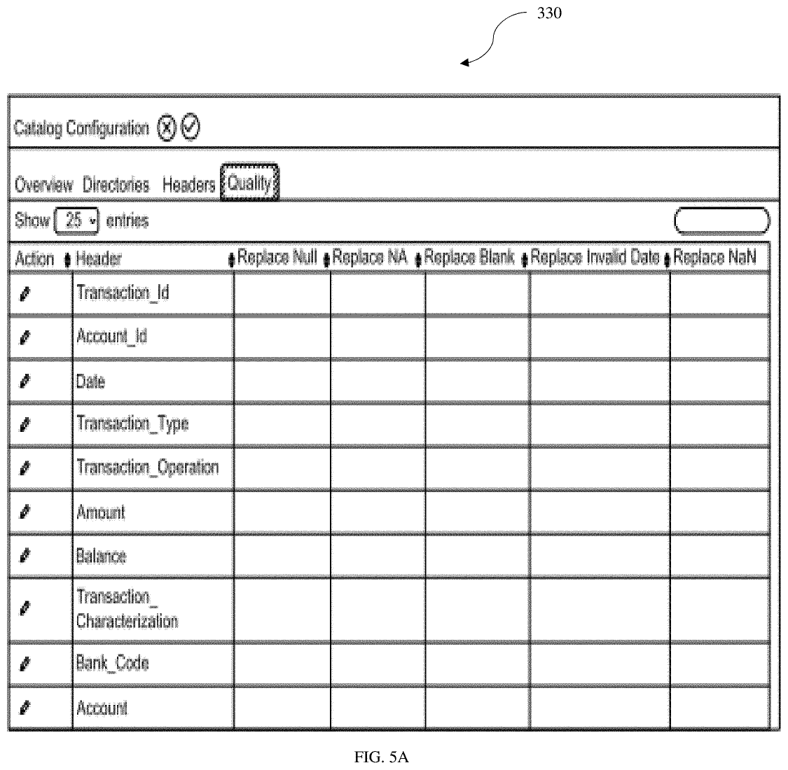

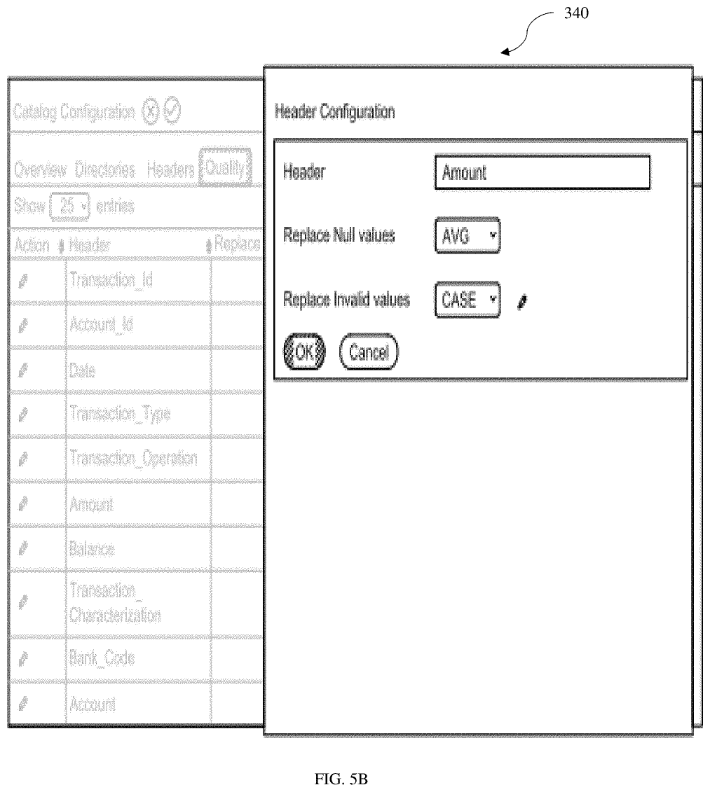

FIG. 5A is a graphical user interface screenshot 330 for data quality catalogue for identified anomaly in accordance with an embodiment of the present disclosure. The system 10 provides catalogue feature which enables defining data quality rules as a combination of static and dynamic rules, to fix any non-block able issues with data at run time. The users also have the ability to change these rules using an intuitive web interface, thus empowering them to react to data anomalies (as they are discovered) in almost real time.

FIG. 5B is a graphical user interface screenshot for detailed view of the data quality catalogue, as shown in FIG. 5A in accordance with an embodiment of the present disclosure. The system 10 enables recommendation for replacing dirty, erroneous and missing data with either static constants, dynamic values by executing pre-defined functions, historical column values or data created by combining one or more column values within a row of data.

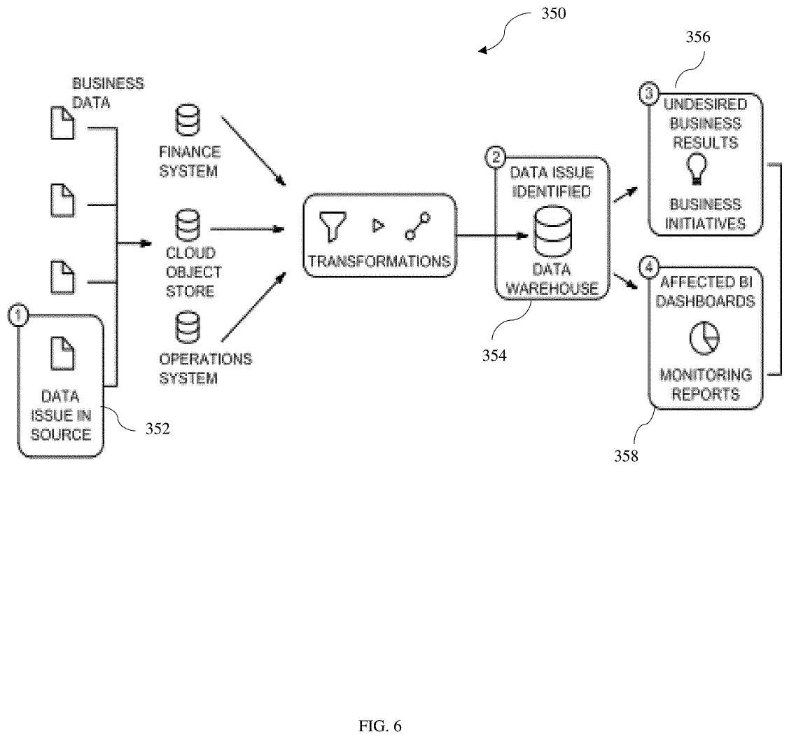

FIG. 6 is a schematic representation showcasing flow of identified anomaly data 350 in downstream data use in accordance with an embodiment of the present disclosure. A data issue 252 is detected in the business data. In such embodiment, if the data issue is not resolved at the root where it is introduced, the corrupt data may enter data warehouse 254. From the data warehouse 254, the corrupt data may affect business results 256 and various monitoring reports 258.

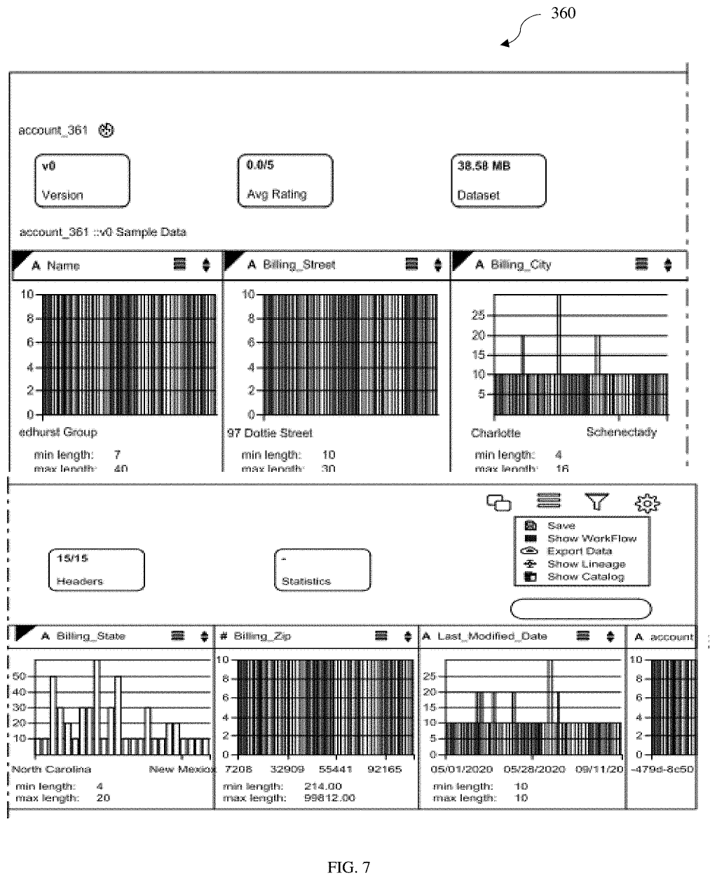

FIG. 7 is a graphical user interface screenshot depicting a dashboard 360 in accordance with an embodiment of the present disclosure. Any user may search or navigate via different options over the dashboard..

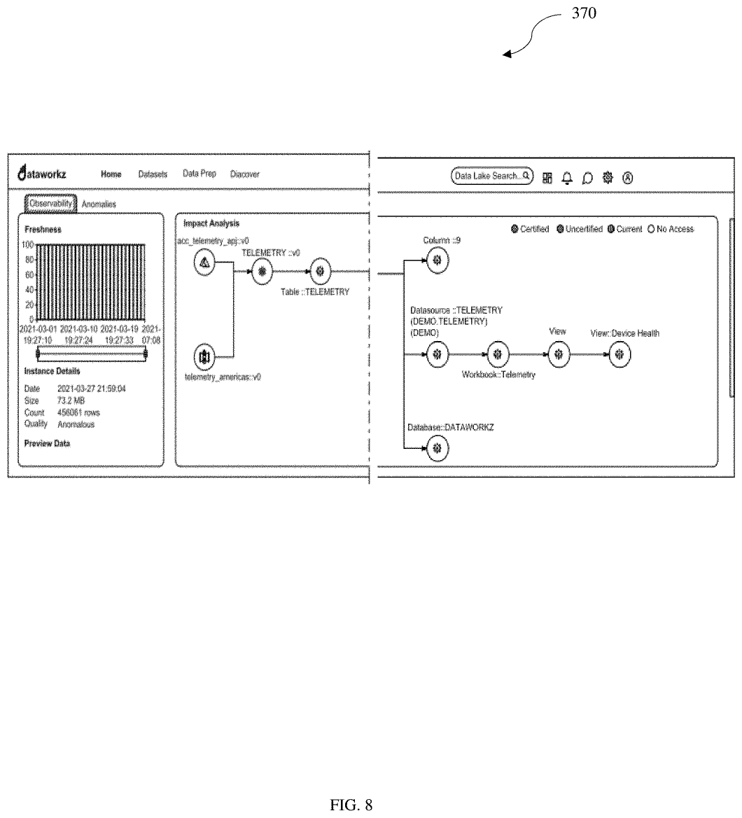

FIG. 8 is a graphical user interface screenshot depicting impact analysis screen for any dataset that has been flagged as anomalous in accordance with an embodiment of the present disclosure. The system 10 enables analysis of impact of the anomaly in the received dataset by creating a graphical representation clearly showing all the downstream datasets that use the anomalous received dataset—either directly or indirectly. In such embodiment, the generation of impact analysis graph for the dataset is based on the analysed impact of the anomaly on the received dataset.

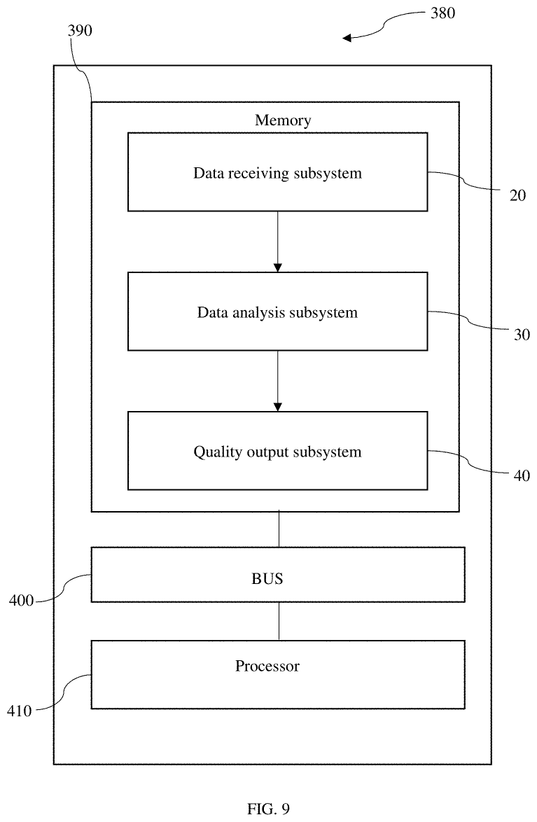

FIG. 9 is a block diagram illustrating various components in the computing system 10, such as those shown in FIG. 1, in accordance with an embodiment of the present disclosure.

The processor(s) 410, as used herein, means any type of computational circuit, such as but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 390 includes a plurality of subsystems stored in the form of an executable program which instructs the processor 410 via bus 400 to perform the method steps illustrated in FIG. 1. The memory 390 has the following subsystems: the data receiving subsystem 20, the data analysis subsystem 30 and the quality output subsystem 40.

The data receiving subsystem 20 is configured to receive a dataset from one or more data sources. The data analysis subsystem 30 is configured to compute data metrics for the received dataset based on the type of the dataset. The data analysis subsystem 30 is also configured to assign a domain label for each of the received dataset using a natural language processing model.

The data analysis subsystem 30 is also configured to compare the computed data metrics and the assigned domain label for each field of the received dataset with stored values of data metrics and domain label for pre-processed non-anomalous datasets to determine one or more deviations.

The data analysis subsystem 30 is also configured to determine the statistical difference between the received dataset and the pre-stored dataset. The quality output subsystem 40 is configured to output the determined statistical difference on a user interface.

Computer memory elements may include any suitable memory device(s) for storing data and executable program, such as read-only memory, random access memory, erasable programmable read-only memory, electrically erasable programmable read only memory, hard drive, removable media drive for handling memory cards. and the like. Embodiments of the present subject matter may be implemented in conjunction with program modules, including functions, procedures, data structures, and application programs, for performing tasks, or defining abstract data types or low-level hardware contexts. The executable program stored on any of the above-mentioned storage media may be executable by the processor(s) 410.

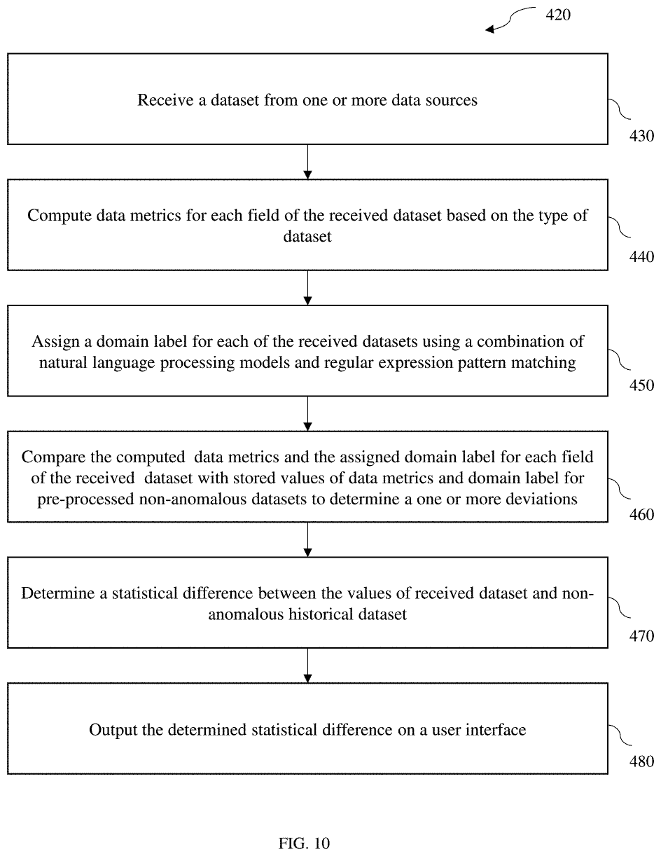

FIG. 10 is a process flowchart illustrating an exemplary method 420 for managing dataset quality in a computing environment in accordance with an embodiment of the present disclosure. At step 430, a dataset is received from one or more data sources. In one aspect of the present embodiment, the dataset is received from the one or more data sources by a data receiving subsystem 20. In another aspect of the present embodiment, the dataset comprises at least one or more columns/fields which further comprises numerical type, date type, datetime type or text type.

At step 440, data metrics are computed for each field of the received dataset based on the type of the dataset. In one aspect of the present embodiment, data metrics are computed for each field of the received dataset based on the type of the dataset by a data analysis subsystem 30. In another aspect of the present embodiment, data metrics comprises null values, blank values, total unique value count, and total record count, minimum value, maximum value, the average value (if applicable), the ratio of null values count to total record count and the ratio of unique values count to total record count for each field.

At step 450, the domain label is assigned for each of the received datasets using a combination of natural language processing models and regular expression pattern matching technique. In one aspect of the present embodiment, the domain label is assigned for each of the received datasets by the data analysis subsystem 30.

At step 460, the computed data metrics and the assigned domain label for each field of the received dataset are compared with stored values of data metrics and domain label for pre-processed non-anomalous datasets to determine a one or more deviations. In one aspect of the present embodiment, the computed data metrics and the assigned domain label for each field of the received dataset are compared with stored values of data metrics and domain label for pre-processed non-anomalous datasets by the data analysis subsystem 30. The determined one or more deviations indicate the presence of an anomaly in the received dataset.

At step 470, a statistical difference between values of received dataset and non-anomalous historical dataset is determined based on the comparison. In one aspect of the present embodiment, statistical difference between the values of received dataset and non-anomalous historical dataset is determined by the data analysis subsystem 30. In another aspect of the present embodiment, the statistical difference indicates data quality of the received dataset. In yet another aspect of the present embodiment, a notification message is generated based on the determined statistical difference and/or difference in domain label. The values of the received dataset comprises computed data metrics and the and the assigned domain label.

At step 480, the determined statistical difference is outputted on a user interface. In one aspect of the present embodiment, the determined statistical difference is outputted on the user interface by a quality output subsystem 40. In such embodiment, one or more solutions are generated for rectifying the determined one or more data quality issues based on one or more data quality rules.

The method 420 further comprises storing of the computed one or more data metrics of received dataset and the assigned domain label for each of the received dataset. In one aspect of the present embodiment, storing is facilitated by a storage subsystem.

The method 420 further comprises generating an alert message, in response to the anomaly. In one aspect of the present embodiment, the generating of the alert for the anomaly is facilitated by the data dashboard subsystem. The alert message indicates the presence of an insight.

The method 420 further comprises generating a recommendation message to a user based on the generated alert. In one aspect of the present embodiment, the recommendation message is generated by the data dashboard subsystem. In another aspect of the present embodiment, the generated recommendation message comprises one or more actions to be performed on the dataset. The method 420 also further enables capturing one or more actions performed by the user (either accept or reject system suggested deviations) in response to the notification and learn from the one or more actions (of the past) to make better recommendations (in the future). In one aspect of the present embodiment, the database is updated with the learnt one or more actions performed on the dataset.

The method 420 further comprises analysing impact of the anomaly on the received dataset. In such embodiment, impact analysis graph is generated for the received dataset clearly showing all the downstream datasets that use the received dataset—either directly or indirectly.

Various embodiments of the present disclosure disclose a system for managing dataset quality in a computing environment. The system checks consistency of the dataset. The disclosed system removes the conventional time requirement for validating and fixing data errors. The manual process is replaced by defining dynamic data quality rules that are executed automatically as dataset is being processed in the system. Moreover, the disclosed system is compatible with variety of data sources.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for managing dataset quality in a computing environment, the system comprising:
a hardware processor; and
a memory coupled to the hardware processor, wherein the memory comprises a set of program instructions in the form of a plurality of subsystems, configured to be executed by the hardware processor, wherein the plurality of subsystems comprises:
a data receiving subsystem configured to receive a dataset from one or more data sources, wherein the received dataset comprises at least one or more columns and fields which comprises numerical type, date type, date time type, or textual type, wherein the received dataset comprises one or more field(s) and an optional header;
a data analysis subsystem configured to:
compute data metrics for each field of the received dataset based on the type of the dataset;
assign domain label for each field of the received dataset using a combination of natural language processing models and regular pattern matching;
compare the computed data metrics and the assigned domain label for each field of the received dataset with stored values of data metrics and the domain label for pre-processed non-anomalous datasets to determine one or more deviations, wherein each of the one or more deviations indicate the presence of an anomaly in the received dataset; and
determine a statistical difference existing between values of the received dataset and the pre-stored non-anomalous datasets, wherein the significant statistical difference between received dataset and pre-stored non-anomalous datasets indicates data quality issue with a specific field of the received dataset; and
a quality output subsystem configured to output the determined statistical difference on a user interface.

2. The system of claim 1, further comprising a storage subsystem configured to store in a database the computed data metrics of the received dataset and the assigned domain label for each of the received datasets.

3. The system of claim 1, further comprising a data dashboard subsystem configured to:
generate an alert message, in response to the anomaly at each field level, based on comparing the pre-stored non-anomalous datasets for data metrics and the domain label with the values in the received dataset; and
generate a notification message to a user based on the generated alert, wherein the generated notification message comprises details about the identified deviation (s) and one or more actions to be performed on the dataset.

4. The system of claim 1, wherein the computed data metrics for each of the fields of the numeric type comprises information representative of null values, total record count, minimum value, maximum value, average value, difference between minimum and maximum values, the ratio of null values count to total record count and the ratio of unique values count to total record count.

5. The system of claim 1, wherein the computed data metrics for each of the fields of text type comprises information representative null values, blank values, total unique value count, total record count, minimum number of characters, maximum number of characters, average number of characters, the ratio of null values count to total record count and the ratio of unique values count to total record count.

6. The system of claim 1, wherein in assigning the domain label, the data analysis subsystem is configured to:
determine data set patterns associated with the each field of the received datasets based on the regular expression matching technique and the natural language processing model; and
classify the each field of the received dataset into one or more domain categories based on the determined dataset patterns.

7. The system of claim 1, wherein the domain label comprises information related to one of—social security number, credit card number, phone number, email address, individual name, address information, gender, dates, URLs, zip codes, locations, company names, products, political or religious organization.

8. The system of claim 1, wherein in determining of the statistical difference, the data analysis subsystem is configured to generate a notification message based on at least one of the determined statistical difference between data metrics values or change in data semantics corresponding to the assigned domain label.

9. The system of claim 1, further comprising:
periodic detection of presence of new datasets being pushed into data lake via a data crawler; and
tagging and storing the detected new dataset in the database.

10. The system of claim 1, further comprising:
capturing one or more actions performed by the user in response to the notification and learning from the captured one or more actions; and
updating the database with the learnt one or more actions performed on the dataset.

11. The system of claim 1, further comprising:
analysis of impact of the anomaly on the received dataset in an enterprise; and
generation of impact analysis graph for the dataset based on the analysed impact of the anomaly on the received dataset.

12. The system of claim 1, further comprising:
determination of one or more data quality issues associated with the received dataset based on the determined statistical difference; and
generation of one or more solutions for rectifying the determined one or more data quality issues based on one or more data quality rules.

13. A method for managing dataset quality in a computing environment, the method comprising:
receiving, by a processor, a dataset from one or more data sources, wherein the received dataset comprises at least one or more columns and fields which comprises numerical type, date type, date time type or textual type, wherein the received dataset comprises one or more field(s) and an optional header;
computing, by the processor, data metrics for each field of the received dataset based on the type of dataset, computed data metrics include null values, blank values, total unique value count, total record count, minimum value, maximum value, average value, the ratio of null values count to total record count and the ratio of unique values count to total record count;
assigning, by the processor, a domain label for each of the received datasets using a combination of natural language processing models and regular expression pattern matching technique;
comparing, by the processor, the computed data metrics and the assigned domain label for each field of the received dataset with stored values of data metrics and the domain label for pre-processed non-anomalous datasets to determine one or more deviations, wherein each of the one or more deviation indicates presence of an anomaly in the received dataset;
determining, by the processor, a statistical difference between values of received dataset and the pre-stored non-anomalous datasets, wherein the statistical difference between the received dataset and the pre-stored non-anomalous datasets indicates data quality issue with specific fields of the received dataset; and
outputting, by the processor, the determined statistical difference on a user interface.

14. The method of claim 13, further comprising storing of the computed data metrics of the received dataset and the assigned domain label for each of the received datasets in a database.

15. The method of claim 13, further comprising generating an alert message, in response to the anomaly, based on comparing the pre-stored non-anomalous datasets for data metrics and the domain label with the values in the received dataset.

16. The method of claim 15, further comprising generating a notification message to a user based on the generated alert, wherein the generated notification message comprises details about the identified deviation(s) and one or more actions to be performed on the dataset.

17. The method of claim 13, wherein assigning the domain label for each of the received datasets comprises:
determining data set patterns associated with the each field of the received datasets based on the regular expression matching technique and the natural language processing model; and
classifying the each field of received datasets into one or more domain categories based on the determined dataset patterns.

18. The method of claim 13, wherein determining either the statistical difference or change in the domain label further comprises generating a notification message based on at least one of the determined statistical difference between data metrics values or change in data semantics corresponding to the assigned domain label.

19. The method of claim 13, further comprising:
periodically detecting presence of new datasets in the lake via a data crawler; and
tagging and storing the detected new datasets in the database.

20. The method of claim 13, further comprising:
capturing one or more actions performed by the user in response to notification and learning from the captured one or more actions; and
updating the database with the learnt one or more actions performed on the dataset.

21. The method of claim 13, further comprising:
analysing impact of the anomaly on the received dataset in an enterprise; and
generating impact analysis graph for the dataset based on the analysed impact of the anomaly on the received dataset.

22. The method of claim 13, further comprising:
determining one or more data quality issues associated with the received dataset based on the determined statistical difference; and
generating one or more solutions for rectifying the determined one or more data quality issues based on one or more data quality rules.

23. A non-transitory computer-readable storage medium having instructions stored therein that, when executed by a hardware processor, cause the processor to perform method steps comprising:
receiving a dataset from one or more data sources, wherein the received dataset comprises at least one or more columns or fields which comprises numerical type, date type, datetime type or text type;
computing data metrics for the received dataset based on type of the dataset;
assigning a domain label for each of the received datasets using natural language processing models and regular pattern matching;
comparing the computed data metrics and the domain label for each field of received dataset with stored values of data metrics and domain label for pre-processed non-anomalous datasets to determine one or more deviations, wherein the determined one or more deviation indicates presence of an anomaly in the received dataset;
determining a statistical difference between values of received dataset and the pre-stored non-anomalous datasets, wherein the determined significant statistical difference indicates data quality issues; and
outputting the determined statistical difference to a user interface.
